(19) United States
(12) Patent Application Publication
(10) Pub. No.: US 2003/0228049 A1
(43) Pub. Date: Dec. 11, 2003

(54) Apparatus and method for inspecting pattern

(75) Inventor: Hiroshi Asai, Kyoto (JP)

Correspondence Address: McDermott, Will & Emery, 600 13th Street, N.W., Washington, DC, 20005-3096, US

(73) Assignee: DAINIPPON SCREEN MFG. CO., LTD.

(21) Appl. No.: 10/442,957

(22) Filed: May 22, 2003

(30) Foreign Application Priority Data
Jun. 11, 2002 (JP) P2002-170109

(51) Int. Cl. G06K 9/00

(52) U.S. Cl. 382/145

(57) ABSTRACT

An inspection apparatus (1) comprises an image pickup part (2) for performing an image pickup of a substrate (9), an operation part (4) to which an image signal is inputted from said image pickup part (2) and a computer (5), and the operation part (4) specifies an inspection image and a reference image from an object image acquired by the image pickup part (2). In the operation part (4), a class teaching part (501) generates a teaching image from the inspection image and an image sampling part (502) samples a plurality of pixels from the teaching image while a feature value calculation part (43) calculates pixel feature values from values of corresponding pixels in the inspection image and the reference image. A dataset generation part (503) generates a dataset of pixel feature values and a class on each of the sampled pixels. A classifier construction part (504) performs training with the dataset to generate a defect check condition and the defect check condition is inputted to an inspection result generation part (44). With this operation, the inspection apparatus (1) can efficiently and appropriately detect defects.

### BACKGROUND OF THE INVENTION

1. Field of the Invention

The present invention relates to a technique for inspecting pattern on an object.

2. Description of the Background Art

In the field of inspection of pattern formed on a semiconductor substrate, a color filter, a shadow mask, a printed circuit board or the like, conventionally, a comparison check method has been mainly performed with multitone images. For example, a differential absolute value image (hereinafter, referred to as “differential image”) which indicates absolute values of the difference in pixel value between an inspection image (an image to be inspected) and a reference image is obtained and a region in the differential image which has pixel values larger than a predetermined threshold value is detected as a defect. In a case of inspection of pattern having periodicity, a plurality of inspection images are sequentially acquired and a comparison check is performed by using an inspection image other than the image under inspection as a reference image.

Such a comparison check has a problem that a threshold value to be determined is changed by variation in graininess of an image due to variation in sharpness. FIGS. 1A and 1B are graphs each showing a histogram of an absolute value of difference (hereinafter, referred to as “differential absolute value”) between pixels of the inspection image and corresponding pixels of the reference image (in other words, a histogram of differential image). FIG. 1A shows a histogram 91a in a case where the graininess of image is large and FIG. 1B shows a histogram 91b in a case where the graininess of image is small. FIGS. 1A and 1B show the histograms of the differential images which are obtained on the same pattern, but the distribution ranges of differential absolute values in the histograms are different due to the difference in graininess of pickup images.

Therefore, for example, when a threshold value T1b is determined in accordance with the histogram 91b of FIG. 1B, if the graininess of the inspection image temporarily becomes large and the distribution of the differential absolute values comes into a state of FIG. 1A, a normal pixel whose differential absolute value is larger than the threshold value T1b and smaller than the threshold value T1a is detected as a pseudo defect. On the other hand, when the threshold value T1a is determined in accordance with the histogram 91a of FIG. 1A, if the graininess of the inspection image temporarily becomes small and the distribution of the differential absolute values comes into a state of FIG. 1B, a defective pixel whose differential absolute value is larger than the threshold value T1b and smaller than the threshold value T1a is not detected.

Then, Japanese Patent Application Laid-Open Gazette No. 2002-22421 proposes a method for removing an effect of variation in sharpness of image (in other words, variation in graininess) by calculating a standard deviation of pixel values of the differential image and normalizing the histogram of the differential image on the basis of the standard deviation.

In order to determine the threshold value to be used for defect detection from the histogram of an image (e.g., differential image), usually, an image with a defect is prepared in advance and a user performs an input for determination of threshold value by using a threshold value determination support program or the like while observing the image displayed on a display and the histogram of the image. For example, in the histogram of a normalized differential image of FIG. 2A, a non-defective portion 921a corresponding to non-defective pixels and a defective portion 921b corresponding to defective pixels in the histogram 921 are clearly discriminated and a threshold value T2 is determined as a value between the non-defective portion 921a and the defective portion 921b.

In a case of histogram 922 of FIG. 2B, however, a border between the non-defective portion and the defective portion is not clear and it is difficult to determine an appropriate threshold value from the histogram 922, and this causes a problem that the user has to find an appropriate threshold value while performing actual inspections.

In another case where a defect check is performed by additionally using a pixel feature value other than a differential absolute value of pixel value (or normalized differential absolute value) (e.g., a feature value of each pixel obtained by edge sampling of a differential image, or the like) as a parameter for defect checks (in other words, where defect checks are performed on the basis of a plurality of pixel feature values), operations for determining an appropriate threshold value becomes complicate.

### SUMMARY OF THE INVENTION

The present invention is intended for a method of inspecting pattern on an object, and it is an object of the present invention to efficiently and appropriately detect defects.

According to the present invention, the method comprises the steps of preparing data of a multitone inspection image acquired from an object, preparing data of a reference image, preparing classification data obtained by adding a class to each pixel of the inspection image, selecting a plurality of pixels in the inspection image, obtaining a feature value on the basis of a value of each of the plurality of pixels and a value of corresponding pixel in the reference image, generating a dataset indicating a combination of a feature value and a class on each of the plurality of pixels, constructing a classifier by training with the dataset to output a classification result in accordance with an inputted feature value, preparing another data of an inspection image and a reference image, selecting one pixel in the inspection image, obtaining a feature value on the basis of a value of the one pixel and a value of corresponding pixel in the reference image, and acquiring a classification result by inputting the feature value to the classifier.

The method of the present invention makes it possible to perform an efficient and appropriate defect checks by using a classifier which is constructed through training.

Preferably, the classification data is data of an image which is obtained by adding a pixel value indicating defective or a pixel value indicating non-defective to each pixel, and the feature value is calculated on the basis of at least one of a differential image between an inspection image and a reference image, a normalized image which is obtained by normalizing pixel values of the differential image with a differential statistics feature value and an image which is obtained by smoothing the normalized image.

According to one preferred embodiment, pattern on the object have periodicity, part of an object image acquired from the object is specified as the inspection image, and a region away from the inspection image by an integral multiple of a cycle of the pattern is specified as the reference image.

According to another preferred embodiment, pattern on the object have periodicity, and an image of a region away from a region on the object corresponding to the inspection image by an integral multiple of a cycle of the pattern is regarded as the reference image.

According to still another preferred embodiment, the reference image is a golden template image.

According to yet another preferred embodiment, the step of constructing the classifier comprises the steps of generating a training dataset and an evaluation dataset from the dataset, generating a classifier by using the training dataset, evaluating the classifier by inputting the evaluation dataset to the classifier, and correcting the training dataset on the basis of an evaluation result.

This allows construction of a further appropriate classifier.

It is preferable that a decision tree, a neural network or a function tree should be used as the classifier.

The present invention is also intended for an apparatus for inspecting pattern on an object and a computer-readable recording medium carrying a program for causing a computer to perform the inspection.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are graphs each showing a histogram of a differential image;

FIGS. 2A and 2B are graphs each showing a histogram of a normalized differential image;

FIG. 3 is a view showing a construction of an inspection apparatus in accordance with a first preferred embodiment;

FIG. 4A is a view showing an inspection image;

FIG. 4B is a view showing a reference image;

FIG. 5 is a view used for explaining calculation of pixel feature values;

FIG. 6 is a view showing a constitution of a computer;

FIG. 7 is a flowchart showing an operation flow for generating a defect check condition;

FIG. 8A is a view showing inspection images;

FIG. 8B is a view showing teaching images;

FIG. 9 is a schematic view showing a decision tree;

FIG. 10 is a block diagram showing a constitution of an inspection apparatus in accordance with a second preferred embodiment;

FIG. 11 is a flowchart showing part of an operation flow for generating a defect check condition;

FIG. 12 is a block diagram showing a constitution of an inspection apparatus in accordance with a third preferred embodiment;

FIG. 13 is a block diagram showing a constitution of an inspection apparatus in accordance with a fourth preferred embodiment;

FIG. 14 is a view used for explaining selection of a pixel value by a reference image selector;

FIG. 15 is a block diagram showing a constitution of an inspection apparatus in accordance with a fifth preferred embodiment;

FIG. 16 is a block diagram showing a constitution of an inspection apparatus in accordance with a sixth preferred embodiment;

FIG. 17 is a block diagram showing a constitution of an inspection apparatus in accordance with a seventh preferred embodiment;

FIG. 18 is a block diagram showing a constitution of an inspection apparatus in accordance with an eighth preferred embodiment;

FIG. 19 is a block diagram showing a constitution of an inspection apparatus in accordance with a ninth preferred embodiment; and

FIG. 20 is a flowchart showing an operation flow of automatic defect checks.

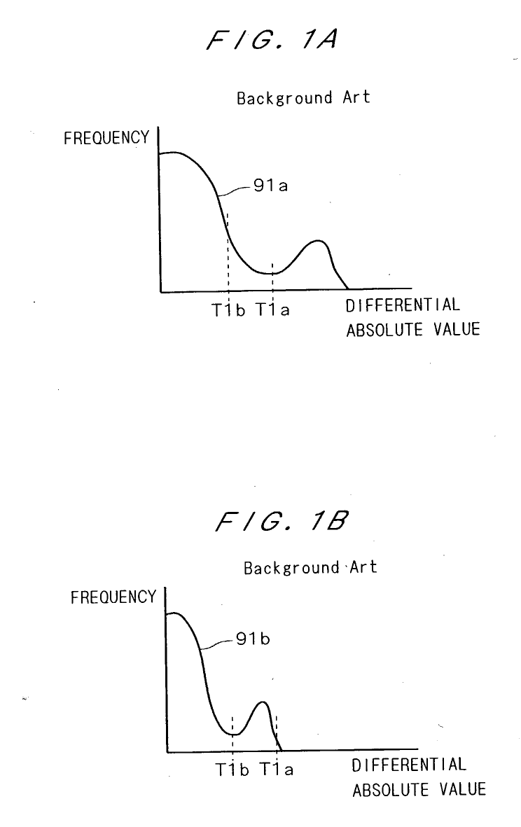

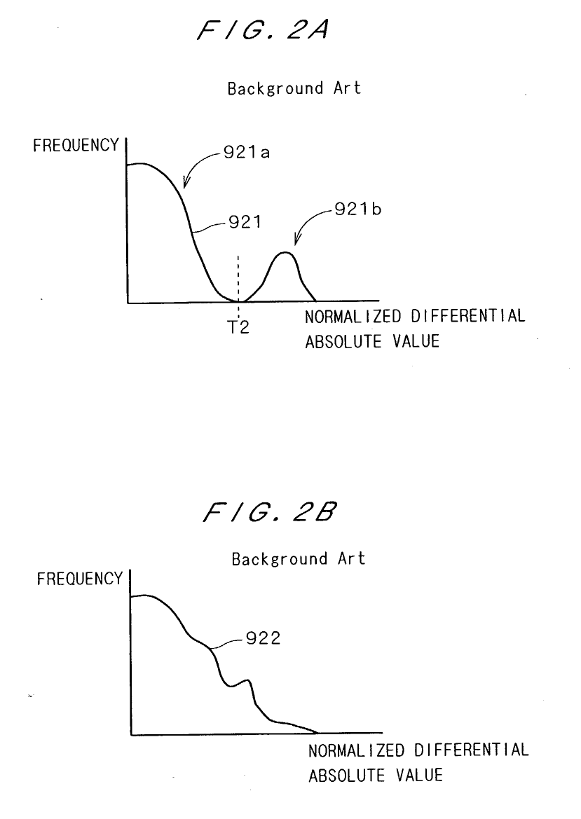

### DESCRIPTION OF THE PREFERRED EMBODIMENTS

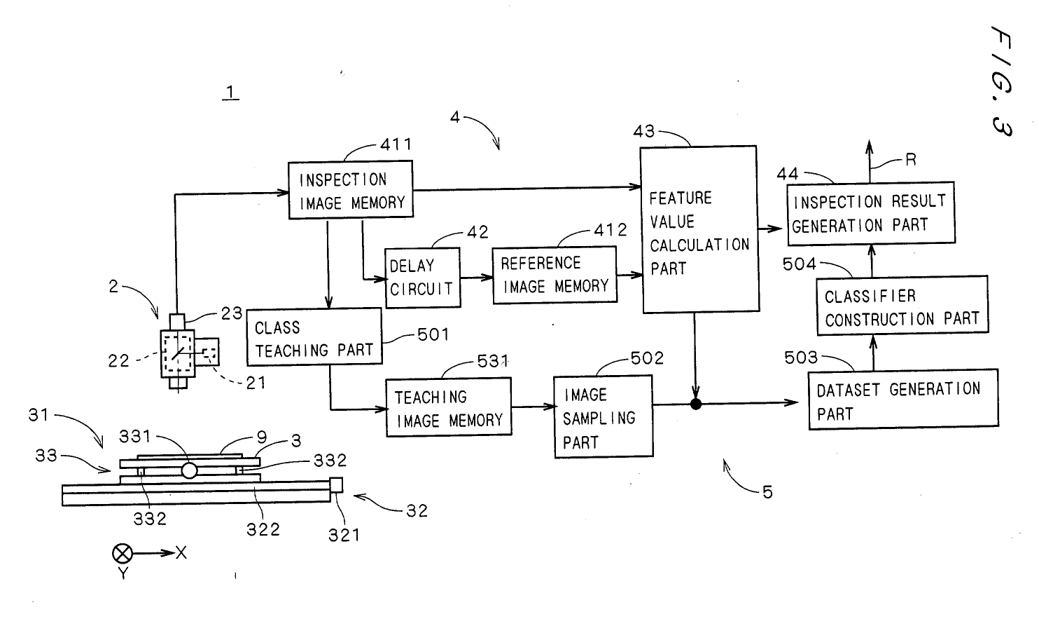

FIG. 3 is a view showing a construction of an inspection apparatus 1 in accordance with the first preferred embodiment of the present invention. The inspection apparatus 1 has an image pickup part 2 for performing an image pickup of a predetermined region on a semiconductor substrate (hereinafter, referred to as “substrate”) 9 to acquire data of a multitone object image, a stage 3 for holding the substrate 9 and a stage driving part 31 for moving the stage 3 relatively to the image pickup part 2.

The image pickup part 2 has a lighting part 21 for emitting an illumination light, an optical system 22 for guiding the illumination light to the substrate 9 and receiving the light from the substrate 9 and an image pickup device 23 for converting an image of the substrate 9 formed by the optical system 22 into an electrical signal. The stage driving part 31 has an X-direction moving mechanism 32 for moving the stage 3 in the X direction of FIG. 3 and a Y-direction moving mechanism 33 for moving the stage 3 in the Y direction. The X-direction moving mechanism 32 has a construction in which a ball screw (not shown) is connected to a motor 321 and moves the Y-direction moving mechanism 33 in the X direction of FIG. 3 along guide rails 322 with rotation of the motor 321. The Y-direction moving mechanism 33 has the same construction as the X-direction moving mechanism 32 and moves the stage 3 in the Y direction along guide rails 332 by its ball screw (not shown) with rotation of its motor 331.

The inspection apparatus 1 further has an operation part 4 constituted of electric circuits and a computer 5 constituted of a CPU which performs various computations, memories which store various information and the like. The operation part 4 receives the electrical signal indicating an object image from the image pickup part 2 to perform automatic defect checks, and the computer 5 generates values of various parameters (i.e., defect check condition) to be used for the automatic defect checks and serves as a control part for controlling the constituent elements of the inspection apparatus 1. In FIG. 3, an inspection image memory 411, a delay circuit 42, a reference image memory 412, a feature value calculation part 43 and an inspection result generation part 44 constitute the operation part 4, and a class teaching part 501, a teaching image memory 531, an image sampling part 502, a dataset generation part 503 and a classifier construction part 504 are constituent elements and functions of the computer 5.

In the inspection apparatus 1, the computer 5 controls the stage driving part 31 to relatively move an image pickup position of the image pickup part 2 to a predetermined position on the substrate 9, and the operation part 4 performs defect checks on an image acquired by the image pickup part 2. Discussion will be made below on the constituent elements of the operation part 4 and an operation for defect checks.

The operation part 4 first receives the signal from the image pickup part 2 and stores data of the object image into the inspection image memory 411. In the inspection image memory 411, each of a plurality of regions in the object image is specified as an available inspection image (image to be inspected). The inspection image memory 411 sequentially outputs pixel values of an inspection image to the feature value calculation part 43 and the delay circuit 42. The delay circuit 42 delays the inputted pixel values as appropriate and outputs the pixel values to the reference image memory 412, and data for one inspection image is stored in the reference image memory 412. The reference image memory 412 sequentially outputs the stored pixel values of the inspection image to the feature value calculation part 43. With this operation, the pixel value from the inspection image memory 411 and the pixel value delayed by one inspection image are inputted to the feature value calculation part 43 at the same time.

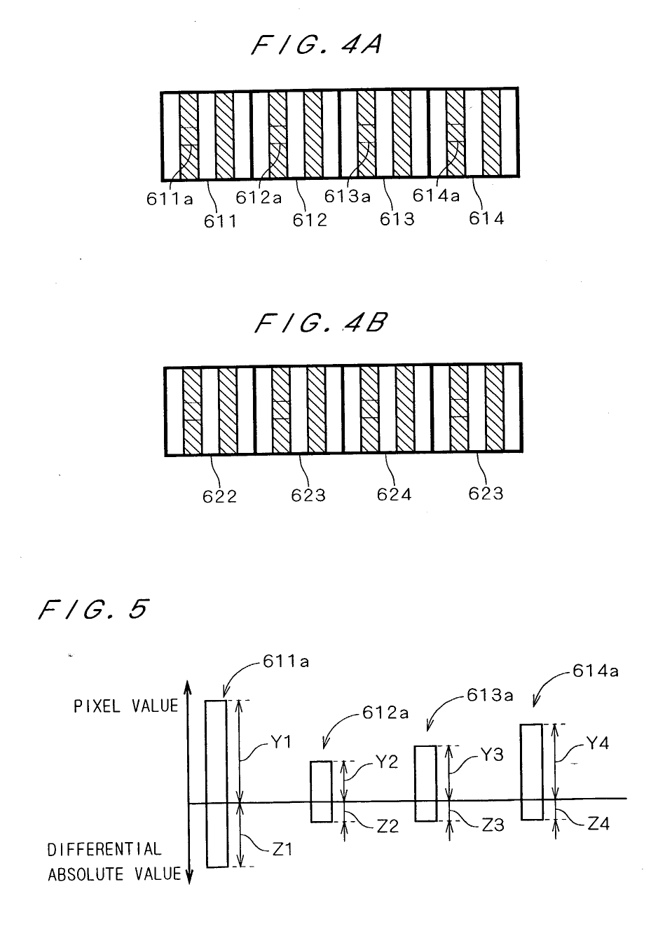

FIG. 4A is a view showing a state where a plurality of inspection images 611 to 614 (hereinafter generally referred to as “inspection images 610”) are stored in the inspection image memory 411 as (part of) an object image. The object image is, for example, an image of a memory region in a die (a region corresponding to one chip) on the substrate 9 having a memory region and a logic region, in which patterns are periodically arranged. Every cycle of the patterns, part of the object image is used as an inspection image. In other words, a region away from one inspection image 610 by an integral multiple of the cycle of the patterns is specified as another inspection image 610.

Herein, assuming that the inspection image memory 411 sequentially outputs the pixel values of the inspection images 610 from the rightmost inspection image 614, when the pixel value of one inspection image 610 is outputted, the corresponding pixel value of the adjacent inspection image 610 on the right side is outputted from the reference image memory 412. Specifically, when one pixel value of the inspection image 613 is outputted from the inspection image memory 411, the corresponding pixel value of the inspection image 614 is outputted from the reference image memory 412. Similarly, when one pixel value of the inspection image 612 or 611 is outputted from the inspection image memory 411, the corresponding pixel value of the inspection image 613 or 612 is outputted from the reference image memory 412, respectively.

When the pixel value of the first inspection image 614 is outputted from the inspection image memory 411, data of the adjacent inspection image 613 is stored into the reference image memory 412 in advance (for example, data of the inspection image 613 is outputted from the inspection image memory 411 as dummy data), and the corresponding pixel values of the inspection images 614 and 613 are outputted from the inspection image memory 411 and the reference image memory 412, respectively, at the same time.

Thus, when a pixel value of each inspection image 610 is outputted from the inspection image memory 411, data of the adjacent inspection image 610 is stored in the reference image memory 412 as data of the reference image in the inspection (exactly, when one pixel value is outputted from the reference image memory 412, the corresponding pixel value of the adjacent inspection image 610 is inputted from the delay circuit 42 for substitution), and the pixel value of the reference image is outputted from the reference image memory 412.

FIG. 4B is a view showing reference images, correspondingly to FIG. 4A. In FIG. 4B, the reference images 622, 623 and 624 are the inspection images 612, 613 and 614, respectively, and the reference images 623, 624, 623 and 622 are used correspondingly to the inspection images 614, 613, 612 and 611 arranged from the right side in FIG. 4A. In the following discussion, these reference images are generally referred to as the “reference images 620”.

The feature value calculation part 43 calculates a signed difference and a differential absolute value which are obtained by subtracting the pixel value of the reference image 620 from the pixel value of the inspection image 610, and the calculated signed difference and differential absolute value are inputted to the inspection result generation part 44 as pixel feature values α and β, respectively. FIG. 5 is a view used for explaining the calculation of pixel feature values on one pixel of each inspection image 610 shown in FIG. 4A. Pixel values with signs 611a, 612a, 613a and 614a in FIG. 5 indicate values of the pixels 611a, 612a, 613a and 614a in FIG. 4A.

When the value of the pixel 614a is outputted from the inspection image memory 411, the value of the pixel 613a is outputted from the reference image memory 412 and then a signed difference Z4 and a differential absolute value Z4 are obtained by subtracting the pixel value Y3 of the pixel 613a from the pixel value Y4 of the pixel 614a (herein, Y3<Y4) and the signed difference Z4 and the differential absolute value Z4 are pixel feature values α and β, respectively.

When the values of the pixels 613a, 612a and 611a are outputted from the inspection image memory 411, the values of the pixels 614a, 613a and 612a are outputted from the reference image memory 412, and the feature value calculation part 43 obtains a signed difference (−Z3) and a differential absolute value Z3 (=Z4) by subtracting the pixel value Y4 from the pixel value Y3, a signed difference (−Z2) and a differential absolute value Z2 by subtracting the pixel value Y2 from the pixel value Y3 (herein, Y2<Y3) and a signed difference Z1 and a differential absolute value Z1 by subtracting the pixel value Y1 from the pixel value Y2 (herein, Y1>Y2), and the signed differences (−Z3), (−Z2) and Z1 and the differential absolute values Z3, Z2 and Z1 are regarded as the pixel feature values α and the pixel feature values β, respectively. In an actual operation, values of the pixels of each inspection image 610 (and values of corresponding pixels in the reference image 620) are sequentially inputted one by one into the feature value calculation part 43 and the pixel feature value α and the pixel feature value β are sequentially obtained.

The inspection result generation part 44 is provided with an electric circuit for outputting a check result on whether defective or non-defective as a signal R, and a defect check condition is inputted from the computer 5 in advance to construct a classifier utilizing a decision tree. Then, every time when the pixel feature values α and β on each pixel in the inspection image 610 is inputted from the feature value calculation part 43, a check result of the pixel is outputted.

Next, discussion will be made on an operation for generation of a defect check condition (i.e., defect check criteria) which is performed as preparation for automatic defect checks by the inspection result generation part 44. The generation of the defect check condition is mainly performed by the computer 5 of FIG. 3.

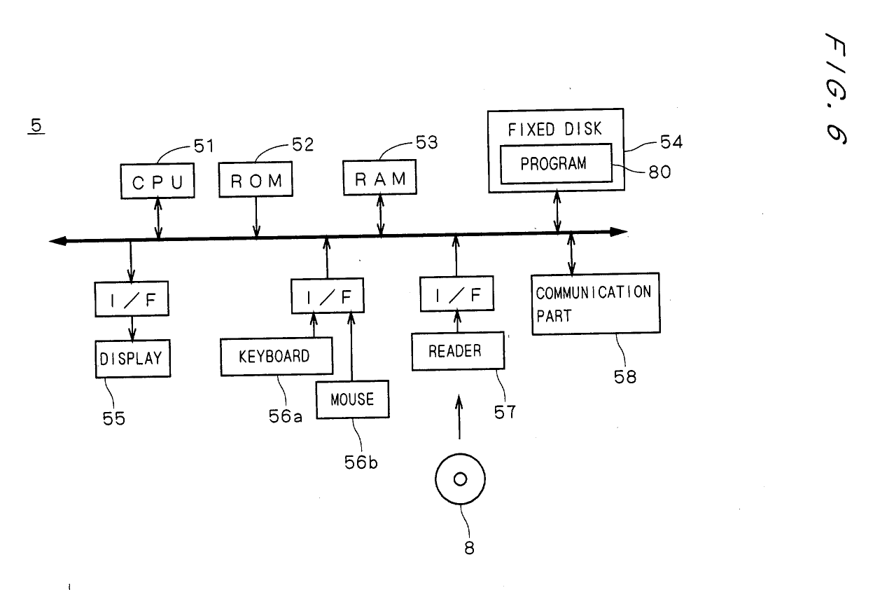

The computer 5 has a constitution of general computer system, as shown in FIG. 6, where a CPU 51 for performing various computations, a ROM 52 for storing a basic program and a RAM 53 for storing various information are connected to a bus line. To the bus line, a fixed disk 54 for storing information, a display 55 for displaying various information such as images, a keyboard 56a and a mouse 56b for receiving an input from a user, a reader 57 for reading information from a computer-readable recording medium 8 such as an optical disk, a magnetic disk or a magneto-optic disk, and a communication part 58 for transmitting and receiving a signal to/from other constituent elements in the inspection apparatus 1 are further connected through an interface (I/F) as appropriate.

A program 80 is read out from the recording medium 8 through the reader 57 into the computer 5 and stored into the fixed disk 54 in advance. The program 80 is copied to the RAM 53 and the CPU 51 executes computation in accordance with the program stored in the RAM 53 (in other words, the computer 5 executes the program), and the computer 5 thereby performs an operation of generating the defect check condition.

In FIG. 3, the teaching image memory 531 corresponds to part of the RAM 53 of the computer 5, and the class teaching part 501, the image sampling part 502, the dataset generation part 503 and the classifier construction part 504 correspond to functions achieved by the CPU 51 and the like. These functions may be achieved by dedicated electric circuits or may be achieved by partially using electric circuits.

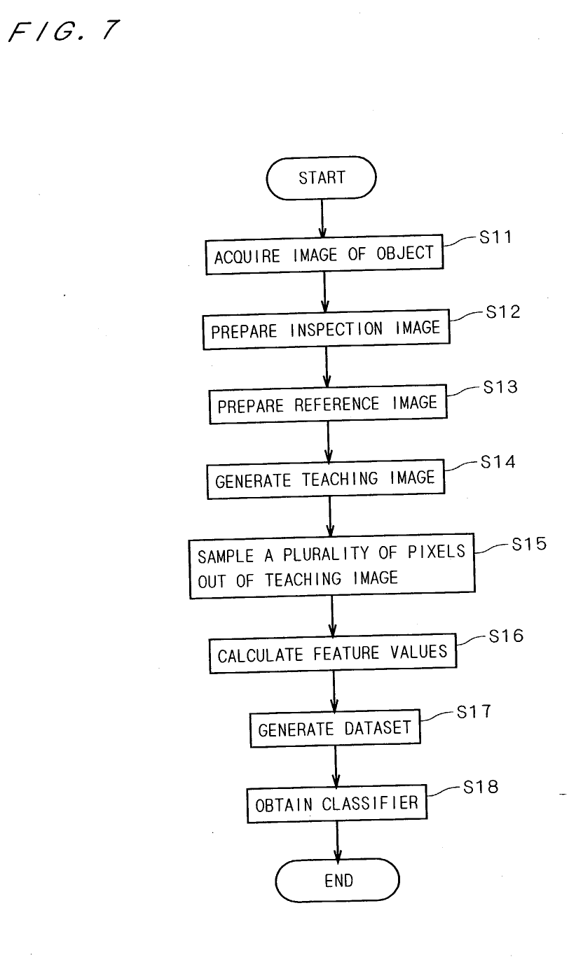

FIG. 7 is a flowchart showing an operation flow of the computer 5 for generating a defect check condition. First, data of an object image is stored in the fixed disk 54 and an inspection image and a reference image in the object image are prepared under the condition that these images can be specified and accessed by the CPU 51 (Steps S11, S12 and S13). There may be a case, similarly to the above-discussed operation of defect checks, where the data of the object image is stored in the inspection image memory 411 and data of one reference image is stored in the reference image memory 412.

Subsequently, the inspection image is displayed on the display 55 and the class teaching part 501 receives decision of a defective region or a non-defective region in the image by a user and processes the image, to generate data of the image to which a class indicating defective or non-defective is added (hereinafter, referred to as “teaching image”) (Step S14).

Specifically, when one of the inspection images 610 shown in FIG. 8A is stored, first, conversion is performed, where the number of tones in the whole inspection image 610 (e.g., 256 tones of brightness represented by 0x00 to 0xFF) is reduced to the half number (i.e., 128 tones represented by 0x80 to 0xFF). Then, only a defective region 610a selected by the user is converted into the darkest pixel value (i.e., 0x00). When the inspection image 610 has an undesirable region for use in construction of a decision tree discussed later, such as a region 610b which is clearly supposed to have a noise, pixel values indicating prohibition of use (e.g., 0x40) are added to the inspection image 610.

FIG. 8B is a view showing teaching images 630 where pixel values indicating defective and pixel values indicating prohibition of use are added and values of non-defective pixels are converted, and in this figure, difference in pixel value is represented by differently hatching. In the teaching images 630 of FIG. 8B, a region 630a corresponding to the defective region 610a of FIG. 8A has pixel values represented by 0x00, a region 630b corresponding to the region 610b having a noise has pixel values represented by 0x40 and non-defective regions in the inspection images 610 are converted in tone to pixel values in a range from 0x80 to 0xFF. Specifically, the class teaching part 501 generates a teaching image to which either a pixel value indicating defective or that indicating non-defective is added to each pixel (or each pixel in part of the image). The generated teaching image 630 is stored into the teaching image memory 531.

The function of the class teaching part 501 is not necessarily achieved by the computer 5 in the inspection apparatus 1 and may be achieved in a separately-provided computer. Further, it is not necessary to add information of defective or non-defective on almost all the pixels of the inspection image 610 and the class information may be added to some pixels needed in the later process.

When the teaching image 630 is stored into the teaching image memory 531, the image sampling part 502 randomly samples a plurality of pixels from the teaching image 630 on the basis of random numbers (Step S15). At this time, one pixel may be duplicately sampled and sampling is performed until a predetermined number of pixels (e.g., 1000 pixels) are acquired. The sampling of pixels may be performed by the user, monitoring the teaching image 630 displayed on the display 55 of the computer 5.

When the sampling of pixels from the teaching image 630 is performed, a value of the pixel in the inspection image 610 and a value of the pixel in the reference image 620 corresponding to each of the sampled pixels are inputted to the feature value calculation part 43, and the feature value calculation part 43 calculates the pixel feature values α and β (Step S16) and outputs the pixel feature values to the dataset generation part 503. In Step S16, the same operation as the feature value calculation part 43 performs may be performed separately by the computer 5.

The dataset generation part 503 generates a dataset by combination of the corresponding pixel feature values α and β and a class (i.e., class indicating defective or non-defective) on the basis of the value of each of the pixels sampled out of the teaching image 630 (Step S17). Table 1 shows an exemplary group of datasets, and each dataset consists of an ID number for identifying a pixel, a pixel feature value α, a pixel feature value β and a class indicating defective or non-defective. As discussed above, when the value of the pixel sampled out of the teaching image 630 is 0x00, “defective” is put in the class item, when the pixel value indicates prohibition of use (0x40 in the above discussion), the dataset is deleted from the group and when the pixel value is one of other values (i.e., 0x80 to 0xFF), “non-defective” is put in the class item.

TABLE 1

| ID Number | Feature Value α | Feature Value β | Class |
|---|---|---|---|
| 0000 | −20 | 20 | Non-Defective |
| 0001 | 50 | 50 | Defective |
| . . . | . . . | . . . | . . . |
| 1999 | 35 | 35 | Defective |

The generated datasets are outputted to the classifier construction part 504, the classifier construction part 504 performs training with the dataset to generate a training result (in other words, parameter values which correspond to the defect check condition which is substantially equal to a classifier), the defect check condition is inputted to the inspection result generation part 44, and a decision tree (in other words, a classifier) which outputs a defect check result in accordance with the pixel feature values is thereby constructed (Step S18). As a result, a high-speed automatic defect checks can be performed in the inspection result generation part 44.

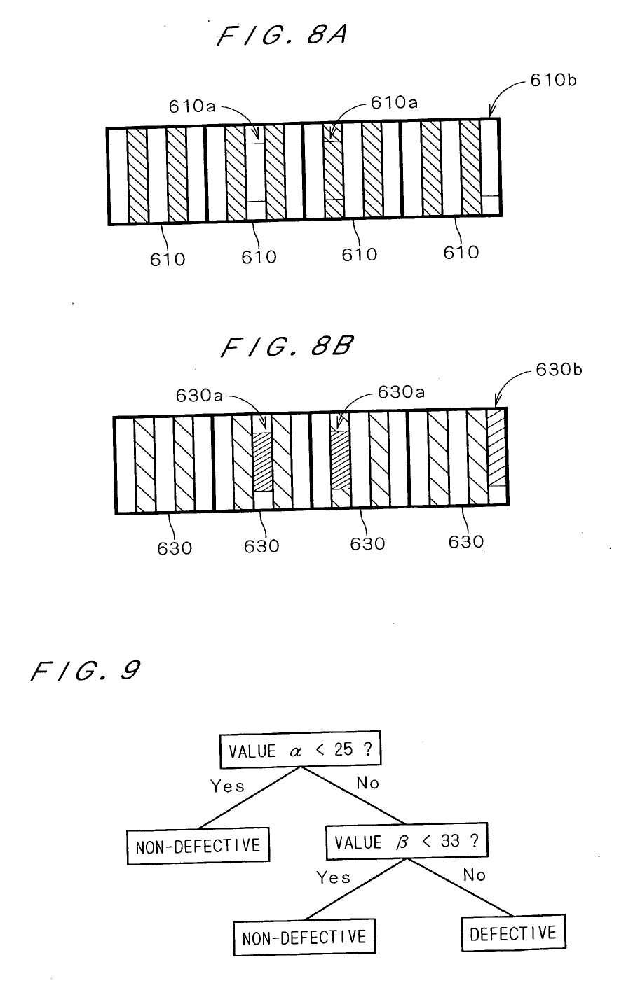

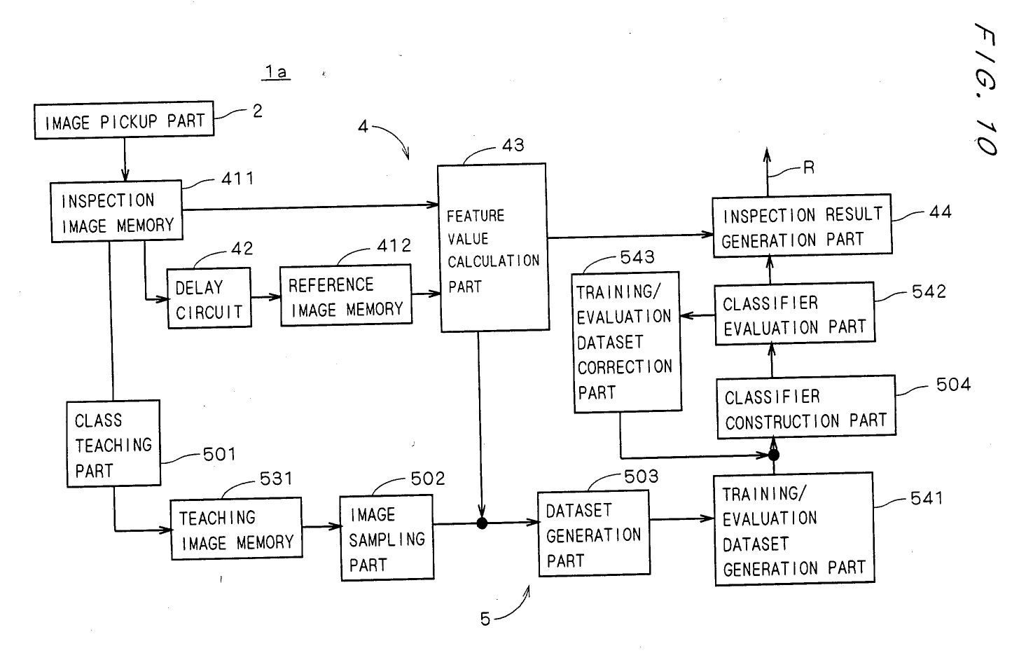

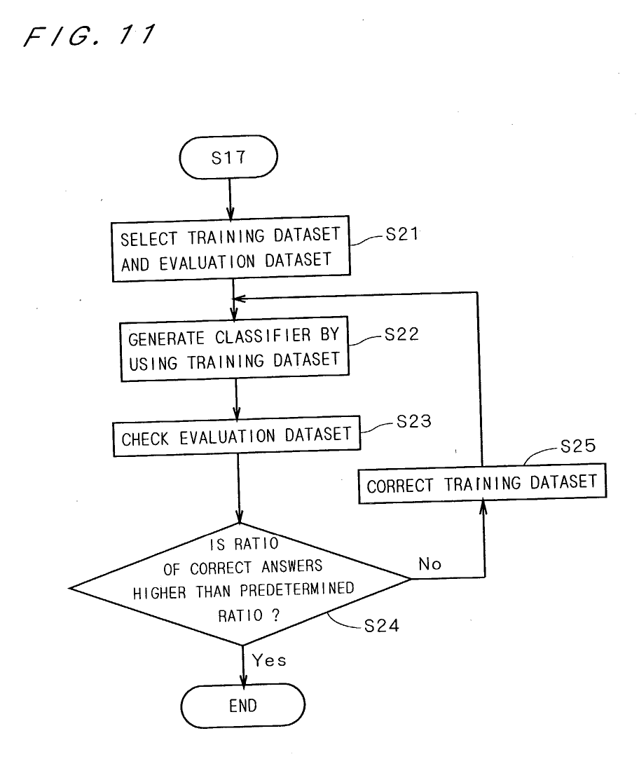

As an algorithm for construction of a decision tree, for example, C4.5 (or ID3) by Quinlan may be used, by which a variable and a threshold value to be allocated are sequentially decided from upper nodes. In this case, an index for evaluating bias of data (i.e., entropy) is used to obtain such a variable and a threshold value as to achieve the most efficient classification. In C4.5 by Quinlan, thus, a small-sized and compact decision tree can be obtained. FIG. 9 is a schematic view showing an exemplary decision tree by which a variable and a threshold value to be allocated to each node as a defect check condition are decided.

Thus, the inspection apparatus 1 can perform an appropriate defect inspection at high speed by using a decision tree. Even when a defect check is performed on the basis of a plurality of feature values, only if the user generates the teaching image 630, the defect check condition is automatically generated and an efficient defect inspection can be performed without any complicate operation.

In a case of higher-level defect checks, the inspection result generation part 44 is provided with an electric circuit which performs checks by using a neural network or a function tree (e.g., a function tree constructed by genetic algorithm), and the classifier construction part 504 generates a defect check condition in accordance with the neural network or the function tree and outputs the defect check condition to the inspection result generation part 44. The checks (i.e., classifications) using a neural network or a function tree ensures high-level performance of inspection, though it takes a longer time than that using a decision tree since the neural network or the function tree generally includes floating point arithmetic. Therefore, in a case of high-speed defect checks, it is preferable to use a decision tree and in a case of high-level defect checks, it is preferable to use a neural network or a function tree.

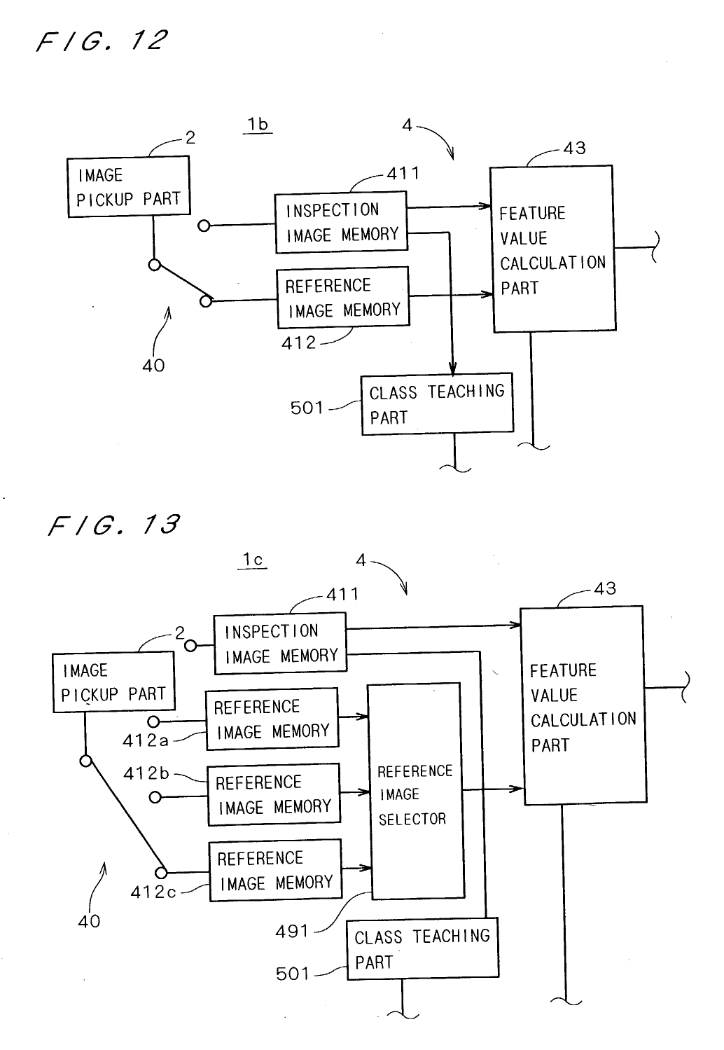

FIG. 10 is a block diagram showing a constitution of an inspection apparatus 1a in accordance with the second preferred embodiment. In the inspection apparatus 1a, a training/evaluation dataset generation part 541, a classifier evaluation part 542 and a training/evaluation dataset correction part 543 are additionally provided in relation to the classifier construction part 504 in the inspection apparatus 1 of the first preferred embodiment. The additional constituent elements are functions that are achieved by the computer 5. Other constituent elements are the same as those in the first preferred embodiment and are represented by the same reference signs.

An operation of the inspection apparatus 1a for a defect check is the same as that of the inspection apparatus 1 and an operation for generating a defect check condition is different between these apparatus. FIG. 11 is a flowchart showing an operation flow of the inspection apparatus 1a for generating a defect check condition. Discussion will be made below on functions of the training/evaluation dataset generation part 541, the classifier evaluation part 542 and the training/evaluation dataset correction part 543 and the operation of the inspection apparatus 1a for generating a defect check condition.

The operation of the inspection apparatus 1a for generating a defect check condition is the same as that of the first preferred embodiment until a plurality of datasets are generated in the dataset generation part 503 (Steps S11 to S17 of FIG. 7). When the datasets are generated in the inspection apparatus 1a, the training/evaluation dataset generation part 541 selects a plurality of training datasets and a plurality of evaluation datasets out of the generated datasets (hereinafter, referred to as “original datasets”) (Step S21). The training datasets and the evaluation datasets may be selected by a predetermined number at random from the original datasets or the whole original datasets may be used as the training datasets or the evaluation datasets. In other words, the training datasets and the evaluation datasets are generated as at least part of the original datasets.

Subsequently, the classifier construction part 504 generates a decision tree by using the training datasets (Step S22). The operation for generating the decision tree is the same as that in the first preferred embodiment, but the operation of defect checks in the generation of the defect check condition is performed by software in the computer 5. In other words, generation of the decision tree is performed by software.

When the decision tree is generated, the classifier evaluation part 542 checks the evaluation datasets by using the decision tree (Step S23) to evaluate the decision tree. Specifically, the classifier evaluation part 542 inputs the pixel feature values of the evaluation datasets to the decision tree and compares the check results with the classes of the evaluation datasets to calculate a ratio of correct answers (in other words, a ratio of evaluation datasets on which defect checks are correctly performed by using the decision tree to all the evaluation datasets).

When the result is not lower than a predetermined ratio of correct answers (e.g., 99%), the generated defect check condition is inputted to the inspection result generation part 44. When the calculated ratio of correct answers is lower than the predetermined value, the classifier evaluation part 542 adds a ratio of correct classification on each evaluation dataset to the evaluation dataset and outputs the training datasets and the evaluation datasets to the training/evaluation dataset correction part 543 (Step S24). Step S23 is repeated as discussed later, and the ratio of correct classification is a ratio of numbers of correct classification on whether defective or non-defective to the numbers of defect checks performed by the classifier evaluation part 542 on one evaluation dataset.

The training/evaluation dataset correction part 543 calculates a evaluation value on each evaluation dataset from the transmitted ratio of correct classification on the evaluation dataset. Specifically, when the ratio of correct classification is a (0≦a≦1), a value calculated from (a²+(1−a)²) (in other words, a value which increases as either correct classifications or wrong classifications are made) is the evaluation value on a pixel having a class of non-defective and a value of a² (in other words, a value which increases as correct classifications are made) is the evaluation value on a pixel having a class of defective.

Then, a random sampling, with high priority given to the evaluation datasets having higher evaluation values to some degree, is performed and the sampled datasets are used as corrected training datasets (Step S25). The sampled datasets may be only added to the training datasets or the sampled datasets may replace the training datasets.

The corrected training datasets are transmitted to the classifier construction part 504 and the decision tree is regenerated on the basis of the corrected training datasets (Step S22). In the inspection apparatus 1a, the classifier evaluation part 542 repeats Steps S22 to S25 until a result which is not lower than the predetermined ratio of correct answers is obtained. There may be a case where the limit of numbers of repetition is determined in advance and the repetition of these steps is ended when the number of repetition reaches the limit number. An evaluation dataset on which the ratio of correct classification remains low even when the operation is repeated is deleted from the group of evaluation datasets since there is a possibility that the user may make a wrong specification in generation of the teaching image 630.

Thus, the inspection apparatus 1a can appropriately correct the training datasets and can therefore construct an appropriate classifier with high ratio of correct answers. Further, by appropriately correcting the evaluation datasets, it is possible to suppress deterioration in accuracy of defect checks even if the user makes a wrong teaching of class in the generation of teaching image.

Values other than the ratio of correct answers may be used as the values for evaluating the decision tree, and the decision tree can be evaluated by, for example, a ratio of genuine defect detection (a ratio of datasets which are correctly classified as defective to the evaluation datasets with class of defective) or a ratio of pseudo defect detection (a ratio of evaluation datasets with class of non-defective to the evaluation datasets which are classified as defective).

FIG. 12 is a block diagram showing an inspection apparatus 1b in accordance with the third preferred embodiment. In the inspection apparatus 1b, the signal of the object image outputted from the image pickup part 2 is transmitted to the inspection image memory 411 or the reference image memory 412 through a switch 40. Other constituent elements are the same as those described in the first or second preferred embodiment.

An inspection image in the inspection apparatus 1b is, for example, an image of a pattern formed on each of logic regions of dies arranged on the substrate 9. When an inspection image is acquired in the inspection apparatus 1b, the switch 40 gets connected to a side of the inspection image memory 411 and the stage driving part 31 moves the stage 3 to move the image pickup position of the image pickup part 2 onto a logic region of a die on the substrate 9 (see FIG. 3). Then, data of an object image is stored in the inspection image memory 411 and a region of inspection image in the object image is specified.

When a reference image is acquired, the switch 40 gets connected to a side of the reference image memory 412 and the image pickup position of the image pickup part 2 is moved by the stage driving part 31 to the same position of another die (i.e., an image pickup region away from the previous image pickup region by an integral multiple of the cycle of patterns of the dies) to acquire an image on a logic region of another die. Then, data of the object image acquired by the image pickup part 2 is stored in the reference image memory 412 under the condition that the region of reference image can be specified. Though one object image can not include the inspection image and the reference image since the pattern in the logic region have no periodicity, the reference image can be prepared by performing an image pickup of a region away from the region on the substrate 9 corresponding to the inspection image by an integral multiple of the cycle of patterns of the dies.

When the inspection image and the reference image are acquired, the inspection apparatus 1b generates a defect check condition to perform automatic defect checks, like in the first or second preferred embodiment. Thus, in the inspection apparatus 1b of the third preferred embodiment, by controlling the stage driving part 31 to acquire the inspection image and the reference image in regions away from each other on the substrate 9, it becomes possible to appropriately construct a decision tree and detect a defect of each pixel in the inspection image.

FIG. 13 is a block diagram showing a constitution of an inspection apparatus 1c in accordance with the fourth preferred embodiment. The inspection apparatus 1c has a switch 40 and controls the stage driving part 31 and the switch 40 to input an object image acquired by the image pickup part 2 to the inspection image memory 411 or one of three reference image memories 412a, 412b and 412c (see FIG. 3). Like in the third preferred embodiment, the object image is stored in the inspection image memory 411 under the condition that a region of the inspection image can be specified and a plurality of object images which indicate regions away from one another by an integral multiple of the cycle of patterns of the dies on the substrate 9 are stored in the reference image memories 412a, 412b and 412c under the condition that the respective regions of reference images can be specified.

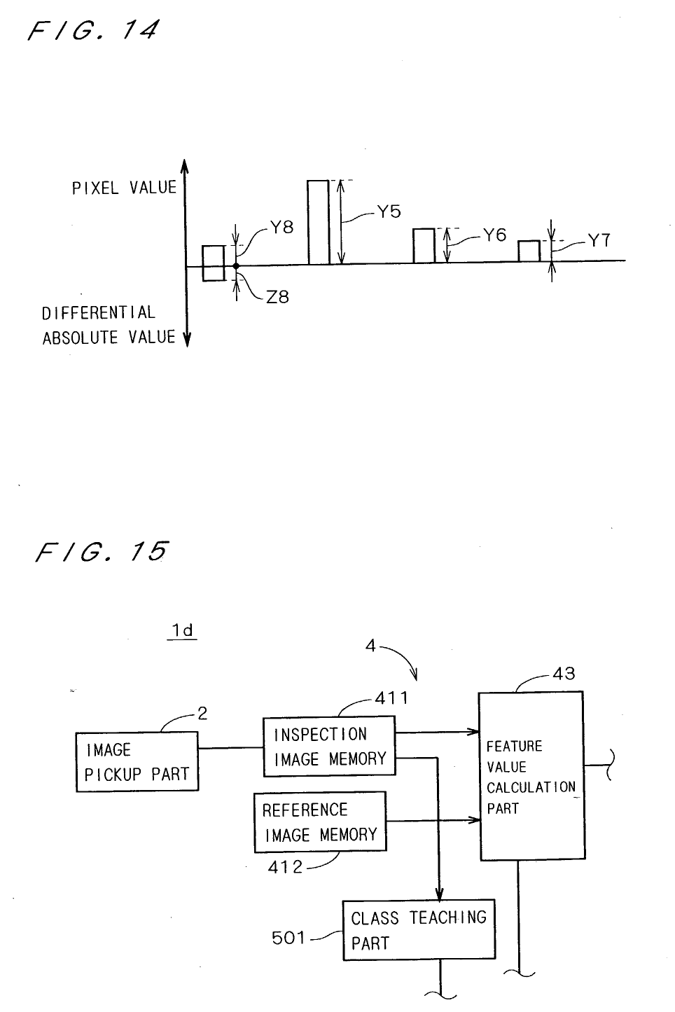

The fourth preferred embodiment is different from the first to third preferred embodiments in that a pixel value to be referred to is decided from a plurality of reference images in calculation of pixel feature values. In the generation of the defect check condition or the calculation of pixel feature values used for the automatic defect check, values of corresponding pixels in the reference images are inputted from the reference image memories 412a, 412b and 412c to a reference image selector 491. The reference image selector 491 selects an intermediate value among a plurality of inputted pixel values and outputs the selected intermediate value. For example, as shown in FIG. 14, when three inputted pixel values are Y5, Y6 and Y7 (herein, Y5>Y6>Y7), the intermediate value among the Y5 to Y7, i.e., Y6 is selected by the reference image selector 491 and outputted to the feature value calculation part 43.

The feature value calculation part 43 calculates a signed difference and a differential absolute value between the pixel value of the inspection image and the selected pixel value of the reference image as pixel feature values. As shown in FIG. 14, when the pixel value of the inspection image is Y8, the feature value calculation part 43 calculates a signed difference (−Z8) and a differential absolute value Z8 by subtracting the pixel value Y6 from the pixel value Y8 (herein, Y8<Y6) as the pixel feature values α and β, respectively. Then, with the pixel feature values α and β which are thus obtained, the construction of classifier through training and the automatic defect check are performed.

Thus, in the inspection apparatus 1c of the fourth preferred embodiment, a plurality of reference images are acquired on one inspection image and selection of the reference image is performed for each pixel. In other words, a substantially new reference image is generated from a plurality of reference images and the pixel feature values are calculated on the basis of the generated reference image. With this operation, even when the pixel value sampled out of one reference image is a value of a defective pixel, only if values of non-defective pixels can be sampled out of two other reference images, it is possible to appropriately construct a classifier and improve the accuracy of defect inspection.

The pixel value which is determined from a plurality of reference images is not necessarily limited to an intermediate value, but there may be a case where an average of pixel values of a plurality of reference images, for example, is calculated and the average value is inputted to the feature value calculation part 43.

There may be another case where the image pickup part 2 is connected to the inspection image memory 411, instead of providing the switch 40, like in the first or second preferred embodiment, and part of the object image is used as an inspection image and a plurality of regions positioned away from the inspection image by integral multiples of the cycle of patterns are stored into the reference image memories 412a to 412c.

FIG. 15 is a block diagram showing an inspection apparatus 1d in accordance with the fifth preferred embodiment. In the reference image memory 412 of the inspection apparatus 1d, data of a golden template image (in other words, an image with no defect or an image presumably with no defect) which is generated from CAD data is stored in advance. Other constituent elements are the same as those described in the first or second preferred embodiment and are represented by the same reference signs.

When the inspection is performed by the inspection apparatus 1d, even if most of the regions to be inspected on the substrate 9 are defective, it is possible to prevent the pixel of the reference image corresponding to each pixel of the inspection image from being a defective pixel and achieve an appropriate construction of a classifier and defect checks. As the golden template image, an image acquired by performing an image pickup of a region to be inspected, which has no defect, on the substrate 9, an image acquired by performing an image processing on this image, such as smoothing or noise addition through contrast control, or the like may be adopted.

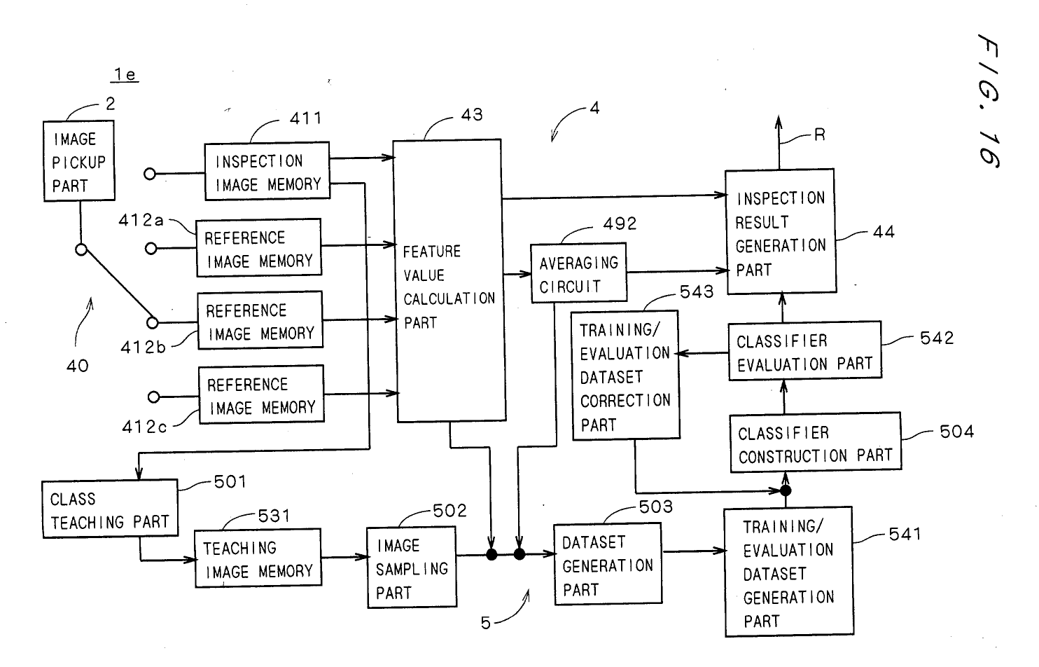

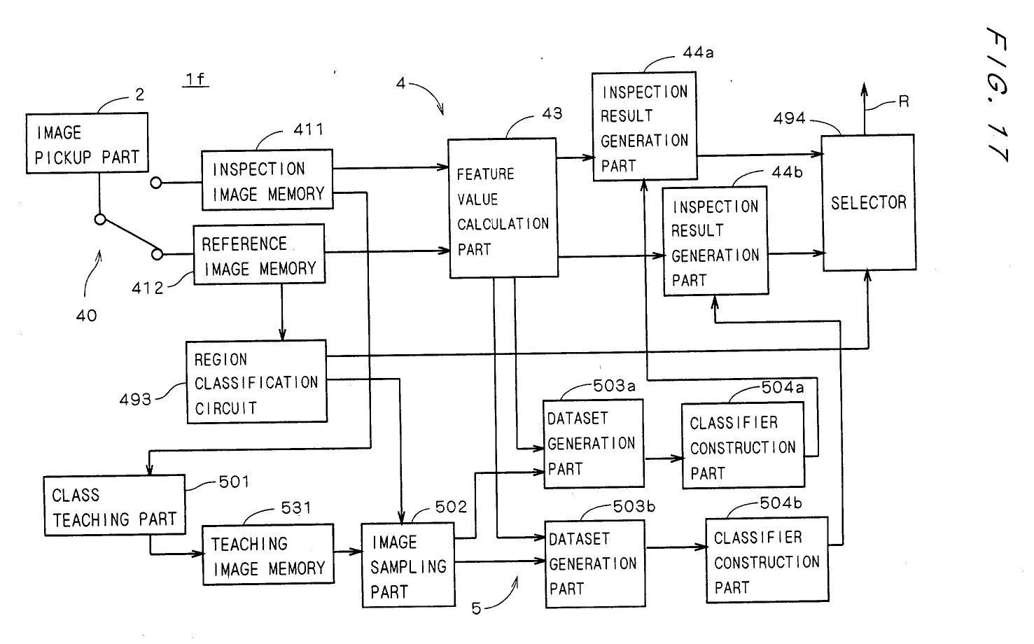

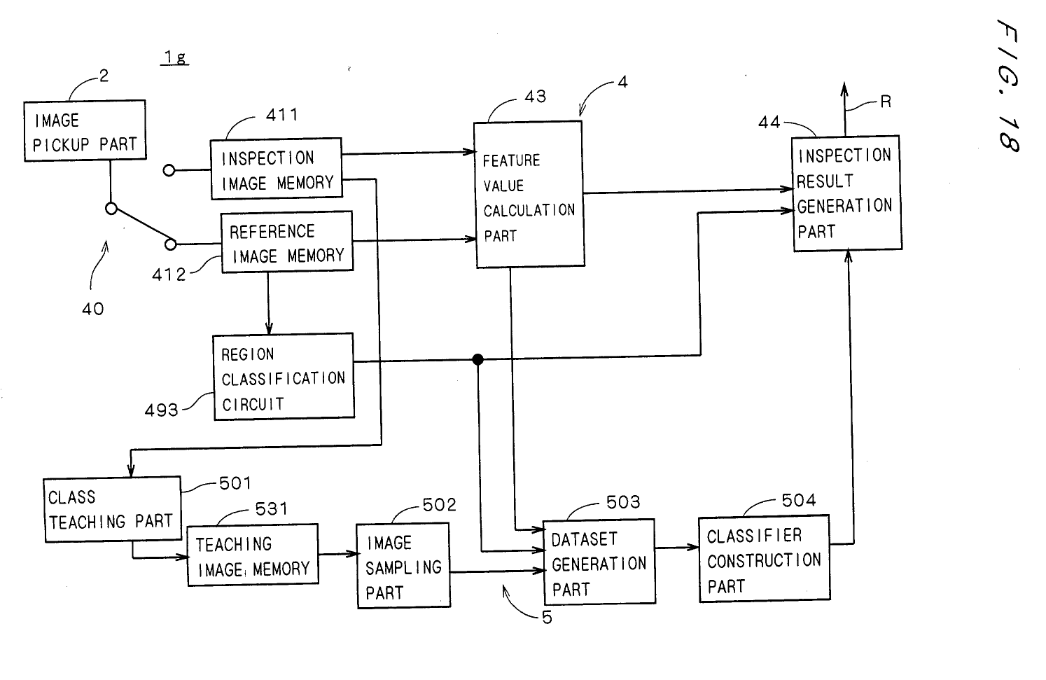

FIG. 16 is a block diagram showing a constitution of an inspection apparatus 1e in accordance with the sixth preferred embodiment. In the inspection apparatus 1e, like in the fourth preferred embodiment, a plurality of reference image memories 412a to 412c are provided, and a pixel value of the inspection image and pixel values of a plurality of reference images are inputted from the inspection image memory 411 and the reference image memories 412a to 412c to the feature value calculation part 43.

In the feature value calculation part 43, standard deviations (totally, three standard deviations) of a plurality of pixel values (or all the pixel values) in differential images which indicate the differential absolute values between the inspection image and the reference images are prepared in advance. When the pixel values of the inspection image and the three reference images are inputted in the generation of a defect check condition and the automatic defect check, three differential absolute values on the pixel value of the inspection image are calculated and these differential absolute values are normalized by the corresponding standard deviations. Specifically, the differential absolute values are divided by the corresponding standard deviations and multiplied by a predetermined coefficient. Since the normalized differential absolute values may be used as values of probability of defect, hereinafter, the normalized differential absolute values are referred to as “error probability values”.

When the three error probability values are obtained, the feature value calculation circuit 43 further multiplies the three error probability values (or obtains a geometric mean) and outputs the result as a pixel feature value to the inspection result generation part 44 in the automatic defect check and to the dataset generation part 503 in the generation of the defect check condition. The inspection apparatus 1e constructs the classifier and performs the defect check by using the pixel feature values which are obtained thus.

The computation in the feature value calculation circuit 43 is substantially equivalent to an operation in which the differential images between the inspection image and the reference images are obtained, the pixel values of the differential images are normalized and a new differential image having the geometric mean of values of corresponding pixels of a plurality of normalized differential images as pixel values is generated. The feature value calculation circuit 43 may be additionally provided with an image memory for storing the newly-generated differential image. The new differential image may be generated as an average-value image of a plurality of normalized differential images.

Thus, in the inspection apparatus 1e of the sixth preferred embodiment, by calculating the pixel feature values on the basis of the differential images normalized by the standard deviations, it is possible to appropriately construct the classifier and perform appropriate defect checks even if there is variation in quality of images from the image pickup part 2.

Next, another exemplary processing for defect checks by the inspection apparatus 1e will be discussed. The inspection apparatus 1e is further provided with an averaging circuit 492 for performing an additional defect check, which obtains an average value of pixel feature value generated by the feature value calculation circuit 43 and pixel feature values of peripheral pixels (which are separately stored immediately before this processing) and outputs the average value to the inspection result generation part 44 or the dataset generation part 503. Since the normalized differential image is substantially smoothed to be used for the construction of classifier and the defect checks, it is possible to detect even a defect which extends across a plurality of pixels, like a stain, (in other words, a defect having a pixel value slightly larger than that of “non-defective” pixel and a relatively large area).

In the feature value calculation circuit 43, it is not necessary to normalize a differential image by a standard deviation but the differential image may be normalized by using a cumulative value of frequencies within a given range in the histogram of the differential absolute values. In other words, the differential image may be normalized on the basis of various differential statistics feature values obtained from statistics on the pixel values of the differential image.

FIG. 17 is a block diagram showing a constitution of an inspection apparatus 1f in accordance with the seventh preferred embodiment. In the inspection apparatus 1f, two dataset generation parts 503a and 503b, two classifier construction parts 504a and 504b and two inspection result generation parts 44a and 44b are provided, and in the operation part 4, a region classification circuit 493 for specifying a region class (i.e., the type of a region) to which each pixel in the inspection image belongs and a selector 494 for selecting one of respective defect check results from the inspection result generation parts 44a and 44b are provided. In the inspection apparatus 1f, like in the third preferred embodiment, the signal of the object image from the image pickup part 2 is outputted to the inspection image memory 411 or the reference image memory 412 through the switch 40. The region classification circuit 493 calculates an average of the pixel values of the reference image at the point in time when the data of the reference image is stored n the reference image memory 412. The average value is prepared as a threshold value (hereinafter, referred to as “region classification threshold value”) for specifying the region class to which each pixel belongs.

In the generation of a defect check condition, when the image sampling part 502 randomly samples a pixel of the teaching image, a value of the corresponding pixel of the reference image is transmitted from the reference image memory 412 to the region classification circuit 493, where a region class is specified on the basis of the defect check threshold value. For the dataset generation parts 503a and 503b, the corresponding region classes are set in advance, respectively, and the class of the pixel and the pixel feature values are transmitted to the dataset generation part 503a or 503b which corresponds to the specified region class. where a dataset is generated. Specifically, the dataset generation parts 503a and 503b each generate a dataset of the pixel which belongs to the corresponding region class. The datasets of respective region classes are transmitted to the corresponding classifier construction parts 504a and 504b and the classifier construction parts 504a and 504b output the generated defect check conditions to the corresponding inspection result generation parts 44a and 44b, respectively. Thus, the inspection result generation parts 44a and 44b construct classifiers for the respective region classes.

In the automatic defect check, the pixel value of the inspection image is inputted from the inspection image memory 411 to the feature value calculation part 43 and then the value of the corresponding pixel of the reference image is inputted from the reference image memory 412 to the feature value calculation part 43 and the region classification circuit 493. The pixel feature values calculated in the feature value calculation part 43 are outputted to the two inspection result generation parts 44a and 44b, and the inspection result generation parts 44a and 44b each perform an automatic defect check and output a check result to the selector 494. On the other hand, the region classification circuit 493 specifies a region class from the pixel value of the reference image and inputs data indicating the specified region class to the selector 494. The selector 494 selects one of the check results from the inspection result generation parts 44a and 44b on the basis of the result on region classification and outputs the selected check result as a signal R.

The inspection apparatus if, which performs defect checks by constructing an appropriate classifier for each region class, can improve the accuracy of defect check results in a case where there are a plurality of region classes in the inspection image, such as a case of inspecting pattern in which an aluminum wiring whose surface has coarse grain is formed in a relatively flat region (hereinafter, referred to as “background region”).

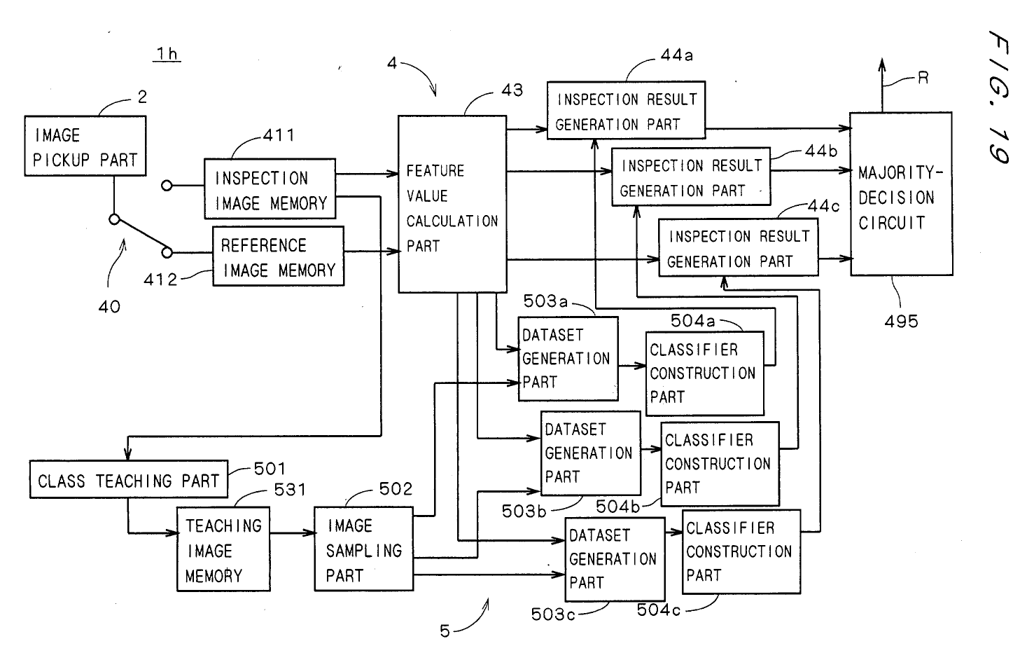

FIG. 18 is a block diagram showing a constitution of an inspection apparatus 1g in accordance with the eighth preferred embodiment. In the inspection apparatus 1g, the output from the region classification circuit 493 is transmitted to the dataset generation part 503 in the generation of a defect check condition and to the inspection result generation part 44 in the automatic defect check. With this operation, a region classification result is additionally provided as one of the pixel feature values of the dataset which is generated by the dataset generation part 503 and this allows defect check results that reflect the region classification to be obtained in the inspection result generation part 44 in the automatic defect check. As a result, like in the seventh preferred embodiment, it is possible to substantially perform defect checks for each region class and improve the accuracy of defect check results.

FIG. 19 is a block diagram showing a constitution of an inspection apparatus 1h in accordance with the ninth preferred embodiment. In the inspection apparatus 1h, three dataset generation parts 503a, 503b and 503c, three classifier construction parts 504a, 504b and 504c and three inspection result generation parts 44a, 44b and 44c are provided, and in the operation part 4, one majority-decision circuit 495 is further provided.

In the generation of defect check conditions, the image sampling part 502 inputs a value of a pixel which is randomly sampled out of the teaching image to the dataset generation parts 503a to 503c and the feature value calculation part 43 inputs the corresponding pixel feature values to the dataset generation parts 503a to 503c. In other words, in the inspection apparatus 1h, three different groups of datasets are generated. The respective groups of datasets are inputted to the classifier construction parts 504a to 504c and the defect check conditions generated in the classifier construction parts 504a to 504c are inputted to the inspection result generation parts 44a to 44c, respectively.

In the automatic defect check, the feature value calculation part 43 inputs the pixel feature values to the inspection result generation parts 44a to 44c, respectively, and the inspection result generation parts 44a to 44c perform the automatic defect checks on the respective inputted pixel feature values and output the respective check results to the majority-decision circuit 495. The majority-decision circuit 495 decides one of the check results on majority rule and outputs the result which is selected on majority rule as the signal R,

With this operation, in the inspection apparatus 1h, even if one of the three defect check conditions is inappropriate or any one of the inspection result generation parts can not perform an appropriate check due to a special pixel feature value, only if other two inspection result generation parts perform appropriate checks, it is possible to achieve an appropriate defect check and improve the accuracy of defect inspection. The three inspection result generation parts 44a to 44c do not necessarily use the same algorithm but may include a classifier using a different algorithm.

In the inspection apparatus 1 and 1a to 1h of the first to ninth preferred embodiments discussed above, the functions of the operation part 4 of the inspection apparatus 1 and 1a to 1h may be performed by the computer 5. A case where the computer 5 performs the same operation of automatic defect checks as the operation part 4 performs in each preferred embodiment will be discussed below.

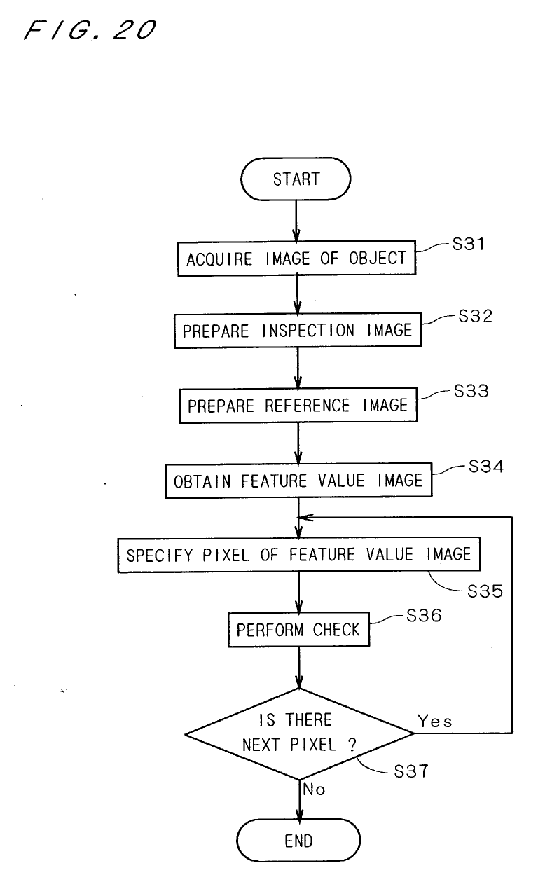

FIG. 20 is a flowchart showing an operation flow of defect checks by the computer 5. In the computer 5, first, in response to the signal from the image pickup part 2, data of an object image is stored into the fixed disk 54 (or may be stored in advance) and an inspection image in the object image is specified by the CPU 51, being prepared accessible (Steps S31 and S32). Further, data of reference images as many as necessary are prepared in the fixed disk 54 (Step S33).

When the operations of the first and second preferred embodiments are performed, for example, part of the object image is specified as the inspection image and a region away from the inspection image by an integral multiple of the cycle of pattern is specified as the reference image. On the other hand, when the reference image(s) is directly acquired by the image pickup part 2, like in the other preferred embodiments, the computer 5 moves the stage 3 by an integral multiple of the cycle of patterns of the dies as appropriate to perform image pickups of the inspection image and the reference images as many as necessary, or a golden template image is prepared as the reference image.

When the inspection image and the reference image are prepared, the CPU 51 obtains a feature value image having a pixel feature value corresponding to each pixel of the inspection image as the pixel value on the basis of the inspection image and the reference image (Step S34). When the same operations as those in the first to fifth, seventh or ninth preferred embodiments are performed, for example, a signed difference image (an image having the signed differences as pixel values) and a differential (absolute value) image (an image having the differential absolute values as pixel values) between the inspection image and the reference image (or a new reference image generated from a plurality of reference images) are obtained as the feature value images. When the same operation as that in the sixth preferred embodiment is performed, the feature value image having the geometric mean of error probability values of pixels as pixel values or an image obtained by smoothing the feature value image is obtained. When the same operation as that in the eighth preferred embodiment is performed, a differential image and a binary image indicating the region classes are obtained.

Then, one pixel of the feature value image (in a case of two or more feature value images, each feature value image) is specified (Steps S35) and the pixel value of the feature value image is inputted to the classifier (in a case of performing the same operation as those in the seventh and ninth preferred embodiments, a plurality of classifiers), where a defect check is performed (Step S36).

By repeatedly performing Steps S35 to S36 for pixels in the feature value image, defect checks on all the pixels in the inspection image are completed (Step S37). Through the above process steps, like in the first to ninth preferred embodiments, it is possible to appropriately perform defect checks. Defect check results are stored into the fixed disk 54 as e.g., binary image data indicating the positions of the defects.

Though it has been discussed that the feature value image is generated in the computer 5, as discussed in the first to ninth preferred embodiments, one pixel feature value may be obtained every time when one pixel is checked. In the case of automatic defect detection by the computer 5, the operation process can be flexibly changed.

Though the preferred embodiments of the present invention have been discussed above, the present invention is not limited to the above-discussed preferred embodiments, but allows various variations.

Defect checks may be performed with the lowered resolution by regarding a plurality of pixels as one pixel. In this case, values each of which derived from a plurality of pixel values (e.g., average values) are used in the generation of a defect check condition and defect checks.

The pixel feature value has only to be a value which is obtained by computation from the pixel value of the inspection image and the corresponding pixel value of the reference image in accordance with a predetermined rule, and three or more types of feature values may be calculated on one pixel.

In the case where the computer performs defect checks, a computer for generating a defect check condition and another computer for performing defect checks may be provided. A computer system to achieve the part for computation in the inspection apparatus may have various constitutions.

The image pickup part 2 and the stage 3 have only to be moved relatively to each other, and there may be a case, for example, where the stage 3 is fixed and a moving mechanism for the image pickup part 2 is provided.

While the invention has been shown and described in detail, the foregoing description is in all aspects illustrative and not restrictive. It is therefore understood that numerous modifications and variations can be devised without departing from the scope of the invention.

What is claimed is:

1. An apparatus for inspecting pattern on an object, comprising:
an image pickup device for performing an image pickup of an object to acquire data of multitone inspection image;
a memory for storing data of reference image and classification data obtained by adding a class to each pixel of said inspection image;
a feature value calculation part for calculating a feature value on the basis of a value of each of a plurality of pixels selected from said inspection image and a value of corresponding pixel in said reference image;
a dataset generation part for generating a dataset indicating a combination of a feature value and a class on each of said plurality of pixels; and
a classifier construction part for constructing a classifier by training with said dataset to output a classification result in accordance with an inputted feature value.

2. The apparatus according to claim 1, wherein
pattern on said object have periodicity and said inspection image is part of an object image acquired by said image pickup device, and
said memory stores a region away from said inspection image by an integral multiple of a cycle of said pattern as said reference image.

3. The apparatus according to claim 1, further comprising
a mechanism for moving said object relatively to said image pickup device,
wherein pattern on said object have periodicity, and said inspection image and said reference image are images of regions which are away from each other by an integral multiple of a cycle of said pattern.

4. A method of inspecting pattern on an object, comprising the steps of:
a) preparing data of a multitone inspection image acquired from an object;
b) preparing data of a reference image;
c) preparing classification data obtained by adding a class to each pixel of said inspection image;
d) selecting a plurality of pixels in said inspection image;
e) obtaining a feature value on the basis of a value of each of said plurality of pixels and a value of corresponding pixel in said reference image;
f) generating a dataset indicating a combination of a feature value and a class on each of said plurality of pixels;
g) constructing a classifier by training with said dataset to output a classification result in accordance with an inputted feature value;
h) preparing another data of an inspection image and a reference image;
i) selecting one pixel in said inspection image;
j) obtaining a feature value on the basis of a value of said one pixel and a value of corresponding pixel in said reference image; and
k) acquiring a classification result by inputting said feature value to said classifier.

5. The method according to claim 4, wherein
said classification data is data of an image which is obtained by adding a pixel value indicating defective or a pixel value indicating non-defective to each pixel.

6. The method according to claim 4, wherein
said feature value is calculated on the basis of at least one of a differential image between an inspection image and a reference image, a normalized image which is obtained by normalizing pixel values of said differential image with a differential statistics feature value and an image which is obtained by smoothing said normalized image in said steps e) and j).

7. The method according to claim 4, wherein
pattern on said object have periodicity,
part of an object image acquired from said object is specified as said inspection image in said step a), and
a region away from said inspection image by an integral multiple of a cycle of said pattern is specified as said reference image in said step b).

8. The method according to claim 4, wherein
pattern on said object have periodicity, and
an image of a region away from a region on said object corresponding to said inspection image by an integral multiple of a cycle of said pattern is regarded as said reference image in said step b).

9. The method according to claim 4, wherein
said reference image is a golden template image in said step b).

10. The method according to claim 4, wherein
a plurality of reference images are prepared before said step (e) and a new reference image is generated from said plurality of reference images.

11. The method according to claim 4, wherein
said step g) comprises the steps of:
g1) generating a training dataset and an evaluation dataset from said dataset;
g2) generating a classifier by using said training dataset;
g3) evaluating said classifier by inputting said evaluation dataset to said classifier; and
g4) correcting said training dataset on the basis of an evaluation result.

12. The method according to claim 11, wherein
said step g) further comprises the step of
repeating said steps g2) to g4).

13. The method according to claim 4, wherein
said classifier is a decision tree.

14. The method according to claim 4, wherein
said classifier is a neural network or a function tree.

15. The method according to claim 4, wherein
a plurality of classifiers are constructed in said step g), and
selection is made among a plurality of classification results acquired by said plurality of classifiers in said step k).

16. A computer-readable recording medium carrying a program for inspection of pattern on an object, wherein execution of said program by a computer causes said computer to perform the steps of:
a) preparing data of a multitone inspection image acquired from an object;
b) preparing data of a reference image;
c) preparing classification data obtained by adding a class to each pixel of said inspection image;
d) selecting a plurality of pixels in said inspection image;
e) obtaining a feature value on the basis of a value of each of said plurality of pixels and a value of corresponding pixel in said reference image;
f) generating a dataset indicating a combination of a feature value and a class on each of said plurality of pixels; and
g) constructing a classifier by training with said dataset to output a classification result in accordance with an inputted feature value.

17. The computer-readable recording medium according to claim 16, wherein
said classification data is data of an image which is obtained by adding a pixel value indicating defective or a pixel value indicating non-defective to each pixel.

18. The computer-readable recording medium according to claim 16, wherein
said feature value is calculated on the basis of at least one of a differential image between said inspection image and said reference image, a normalized image which is obtained by normalizing pixel values of said differential image with a differential statistics feature value and an image which is obtained by smoothing said normalized image in said step e).

19. The computer-readable recording medium according to claim 16, wherein
pattern on said object have periodicity,
part of an object image acquired from said object is specified as said inspection image in said step a), and
a region away from said inspection image by an integral multiple of a cycle of said pattern is specified as said reference image in said step b).

20. The computer-readable recording medium according to claim 16, wherein
pattern on said object have periodicity, and
an image of a region away from a region on said object corresponding to said inspection image by an integral multiple of a cycle of said pattern is regarded as said reference image in said step b).

21. The computer-readable recording medium according to claim 16, wherein
said reference image is a golden template image in said step b).

22. The computer-readable recording medium according to claim 16, wherein
a plurality of reference images are prepared before said step e) and a new reference image is generated from said plurality of reference images.

23. The computer-readable recording medium according to claim 16, wherein
said step g) comprises the steps of:
g1) generating a training dataset and an evaluation dataset from said dataset;
g2) generating a classifier by using said training dataset;
g3) evaluating said classifier by inputting said evaluation dataset to said classifier; and
g4) correcting said training dataset on the basis of an evaluation result.

24. The computer-readable recording medium according to claim 23, wherein
said step g) further comprises the step of
repeating said steps g2) to g4).

25. The computer-readable recording medium according to claim 16, wherein
said classifier is a decision tree.

26. The computer-readable recording medium according to claim 16, wherein
said classifier is a neural network or a function tree.

27. The computer-readable recording medium according to claim 16, wherein execution of said program by said computer causes said computer to further perform the steps of:
h) preparing another data of an inspection image and a reference image;
i) selecting one pixel in said inspection image;
j) obtaining a feature value on the basis of a value of said one pixel and a value of corresponding pixel in said reference image; and
k) acquiring a classification result by inputting said feature value to said classifier.

28. The computer-readable recording medium according to claim 27, wherein
a plurality of classifiers are constructed in said step g), and
selection is made among a plurality of classification results acquired by said plurality of classifiers in said step k).
